(19) United States
(12) Patent Application Publication
(10) Pub. No.: US 2013/0274952 A1
(43) Pub. Date: Oct. 17, 2013

(54) PREDICTIVE POWERTRAIN CONTROL USING DRIVING HISTORY

(71) Applicants: Feisel Weslati, Troy, MI (US); Ashish S. Krupadanam, Rochester Hills, MI (US)

(72) Inventors: Feisel Weslati, Troy, MI (US); Ashish S. Krupadanam, Rochester Hills, MI (US)

(21) Appl. No.: 13/858,164

(22) Filed: Apr. 8, 2013

Related U.S. Application Data
(60) Provisional application No. 61/624,512, filed on Apr. 16, 2012.

(51) Int. Cl. B60W 40/02

(52) U.S. Cl. CPC B60W 40/02
USPC 701/1

(57) ABSTRACT

A method and powertrain apparatus that predicts a route of travel for a vehicle and predicts powertrain loads and speeds for the predicted route of travel. The predicted powertrain loads and speeds are then used to optimize at least one powertrain operation for the vehicle.

### CROSS-REFERENCE TO RELATED APPLICATION

This application claims the benefit of U.S. Provisional Serial No. 61/624,512, filed Apr. 16, 2012.

### GOVERNMENT INTEREST

This invention was made, at least in part, under U.S. Government, Department of Energy, Contract No. DE-EE0002720. The Government may have rights in this invention.

### FIELD

The present disclosure relates to vehicle powertrain control and, more specifically, to predictive vehicle powertrain control based on driving history.

### BACKGROUND

Motorized vehicles include a powertrain operable to propel the vehicle and power the onboard vehicle electronics. The powertrain typically includes an engine that powers the final drive system through a multi-speed transmission. Many of today's conventional, gas-powered vehicles are powered by an internal combustion (IC) engine.

Hybrid vehicles have been developed and continue to be developed. Conventional hybrid electric vehicles (HEVs) combine internal combustion engines with electric propulsion systems to achieve better fuel economy than non-hybrid vehicles. Plugin hybrid electric vehicles (PHEVs) share the characteristics of both conventional hybrid electric vehicles and all-electric vehicles by using rechargeable batteries that can be restored to full charge by connecting (e.g. via a plug) to an external electric power source.

Despite the introduction of hybrid vehicles and improved conventional gas powered vehicles, the automotive industry is continually faced with the challenge of improving fuel economy and reducing emissions without sacrificing vehicle performance. As mentioned above, there are many different types of vehicles in existence today with numerous others being developed for the future. Accordingly, there is a need and desire for a technique for improving fuel economy and reducing emissions without sacrificing vehicle performance that will work with many different types of vehicles.

### SUMMARY

In one form, the present disclosure provides a method of controlling a vehicle powertrain. The method comprises determining a present location of the vehicle; predicting a route of travel for the vehicle from the present location based on the current day and time; predicting powertrain loads and speeds based on the predicted route of travel; and optimizing a powertrain operation based on the predicted powertrain loads and speeds.

The present disclosure also provides a powertrain apparatus for a vehicle. The apparatus comprises a controller adapted to determine a present location of the vehicle; predict a route of travel for the vehicle from the present location based on the current day and time; predict powertrain loads and speeds based on the predicted route of travel; and optimize a powertrain operation based on the predicted powertrain loads and speeds.

In one embodiment, the optimized powertrain operation comprises one of shift scheduling and battery control.

In another embodiment, predicting the route of travel comprises determining if a next segment in a map database associated with a segment corresponding to the present location is traveled more than a predetermined threshold on a similar day and time as the current day and time; and adding the next segment to the predicted route of travel if it is determined that the next segment is traveled more than the predetermined threshold on a similar day and time as the current day and time. In another embodiment, the next segment is not added if additional information indicates that another segment should be added to the predicted route. Additional information may be input from a vehicle to vehicle data source, a vehicle to infrastructure data source, or a navigation system.

Further areas of applicability of the present disclosure will become apparent from the detailed description and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 illustrates a predictive powertrain control system constructed in accordance with an embodiment disclosed herein; and

FIG. 2 illustrates in flowchart form a predictive powertrain control method operating in accordance with an embodiment disclosed herein.

### DETAILED DESCRIPTION

According to the principles disclosed herein, and as discussed below, predictive control of the powertrain of various conventional and hybrid vehicles can be performed to improve fuel economy and emissions using predicted vehicle usage based on the vehicle's driving history. According to the principles disclosed herein, driving history, GPS location and map information are used to predict future loads and speeds for the current trip. In addition, driver inputs will not be required for the method and system disclosed herein to make a prediction of the driver's route and intended destination.

Predicting the loads and speeds of the vehicle for the duration of a trip allows shift scheduling to be performed on conventional vehicles and allows transmission and battery control to be performed on HEVs and PHEVs. For example, predicted trip load and grades can be used to optimize battery charging and discharging locations along the trip. Moreover, the modes of transmission operation (e.g., in electrically variable transmissions) or gear ratio selection on conventional and other HEVs can be optimized. For PHEVs, which are generally designed to operate in two modes (a charge depleting mode or a charge sustaining mode), prediction of battery charging locations can be used to change battery discharging strategy (in the charge depleting mode) to be more or less aggressive.

As will be shown below, GPS and map data for road segments traveled are stored with a time stamp in a non-volatile memory. As used herein, a “road segment” is derived from how navigation systems truncate any road into specific little blocks or segments. Generally, nothing changes on a segment (i.e., a segment will contain a constant speed and direction, there will be no intersections, stop signs, etc.). During vehicle operation, a prediction concerning the next probable on-coming road segment is made based on the relative weighting of several factors such as e.g., history versus function class (i.e., any information from sources other than the previously stored road segment or history), type of road, straightness of the segment, etc. For example, if travel history is weighted heavily, and at the end of segment X there is a history of immediate travel on segment Y, then the probability of travel on segment Y on a route having segment X is large; thus, segment Y will be considered part of the route being traveled. However, if the history information indicates that segments A, B, C, D and E are travelled next, but information from another source (e.g., a vehicle to vehicle source) indicates that segment C is not a good segment to travel and proposes an alternative segment K, segment K will be added to the route if function class is weighed heavily (travel is now changed to segments A, B, K, D, and E instead off segments A, B, C, D and E); if history is weighed heavily, however, the projected route will remain as segments A, B, C, D and E.

As another example, if the vehicle has a history of stopping after segment Z, and the time stamp for segment Z matches closely with the current time, day of week, etc., then the probability of travel after segment Z is low. Once the probability of further travel falls below a calibrated threshold, the route is assumed to be completed and the destination is presumed to have been reached. If the trip continues past segment Z, however, the segment predictions will begin again.

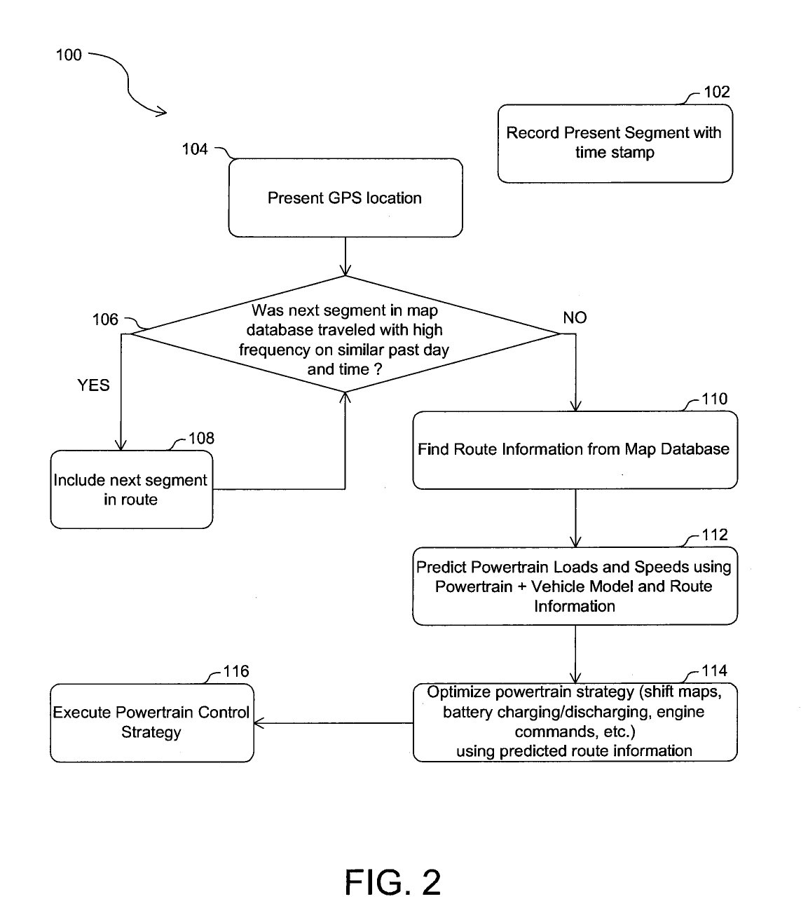

As will be discussed below with reference to FIG. 2, the segment predictions will be used to control the powertrain to improve the fuel economy and emissions in a manner that will not impact the vehicle's driving performance. A model of the vehicle and powertrain dynamics is used to determine speeds and loads on the powertrain for the predicted route and present and past history of travel conditions along the road (such as e.g., traffic density, road conditions, etc.). The predicted speeds and loads on the powertrain can then be used to optimize the shift scheduling of conventional vehicles and the transmission and battery control for HEVs and PHEVs.

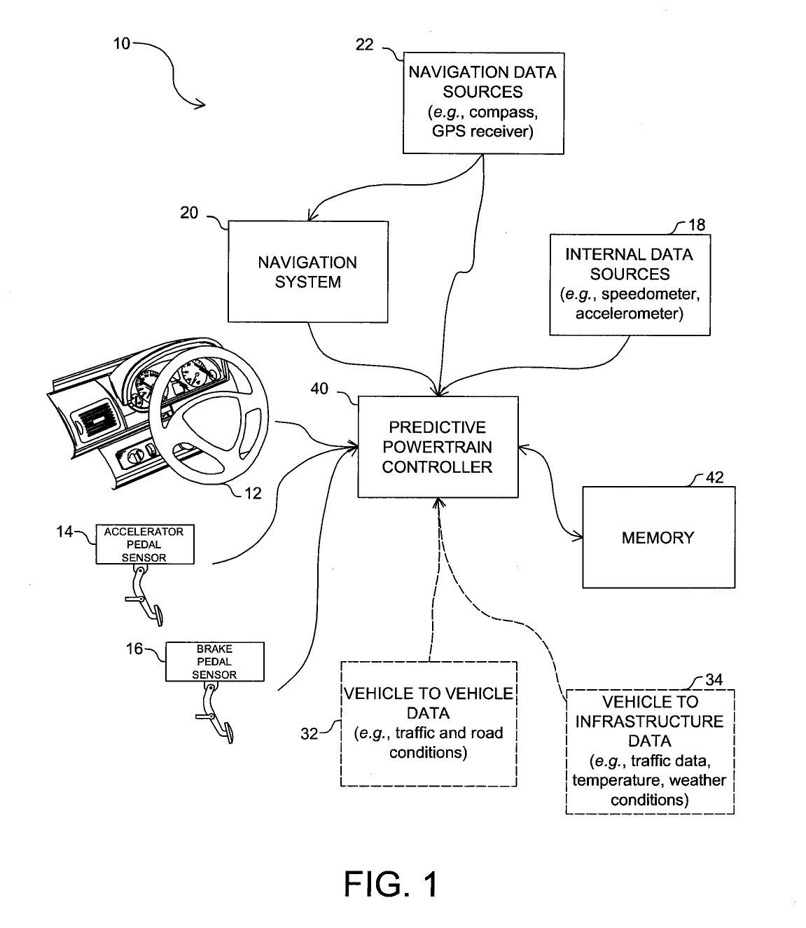

FIG. 1 illustrates a predictive powertrain control system 10 constructed in accordance with an embodiment disclosed herein. The system 10 has a predictive powertrain controller 40, which may be a programmed processor or other programmable controller suitable for performing the method 100 illustrated in FIG. 2 and discussed below in more detail. Associated with the controller 40 is a non-volatile memory 42, which may be part of the controller 40 or a separate component. It should be appreciated that any form of non-volatile memory may be used for memory 42. In addition, the predictive powertrain control programming discussed below is stored in the memory 42. It should be appreciated that the functions performed by the controller 40 can also be integrated into the vehicle's powertrain control software, if desired.

As can be seen in FIG. 1, the predictive powertrain controller 40 receives data and signals from various sources within the vehicle and external to the vehicle. Specifically, the controller 40 inputs data from one or more internal data sources 18 (e.g., speedometer, accelerometer) and driver input information from e.g., the steering column 12, accelerator pedal sensor 14 and brake pedal sensor 16. It is desirable for the controller 40 to be connected to a navigation system 20, one or more navigation data sources 22 (e.g., compass or GPS receiver), one or more external data sources such as a vehicle to vehicle data source 32 and a vehicle to infrastructure data source 34. The input information/data can include e.g., expected trip route and grade (e.g., from the navigation system 20), expected speeds and speed limits (e.g., from the navigation system 20, vehicle to infrastructure data sources such as smart traffic lights, highway information systems, etc.), weather conditions (e.g., wet, dry, icy, windy, etc. from weather service information input e.g., from GPS, vehicle to vehicle or vehicle to infrastructure data sources) or any other information provided by or transmitted by the various illustrated data sources.

FIG. 2 illustrates an example predictive powertrain control method 100 according to the principles discussed herein. The method 100, at step 102, records the present segment with a time stamp including the day of week and the time of day. This step is performed for each new segment that the vehicle travels. The predictive portion of the method 100 begins at step 104 where the present GPS location of the vehicle is determined. At step 106 it is determined if the next segment in the map database was traveled with a high frequency on a similar past day and time. As used herein, “high frequency” relates to a predetermined percentage of travel. Thus, if the next segment has been traveled at or above the predetermined percentage (e.g., greater than 50%), then the next segment has been traveled with a high frequency. It should be noted that the exact percentage satisfying the “high frequency” is not essential and should not be limiting.

If it is determined that the next segment from the map database was traveled with a high frequency (i.e., greater than the predetermined percentage) on a similar past day and time, the method 100 includes the next segment in the current route (step 108) and continues at step 106 to check another “next” segment. Thus, steps 106 and 108 add segments to the predicted route based on route segments (and time stamps) previously stored in the map database.

If at step 106 it was determined that the next segment from the map database was not traveled with a high frequency on a similar past day and time, the method continues at step 110 where stored route information (Le., previously traveled segments) corresponding to the predicted route is retrieved from the map database. The route information preferably includes historical battery charging locations, which are also factors for optimizing the powertrain of PHEVs and similar vehicles. As mentioned above, the prediction of battery charging locations can be used to change battery discharging strategy to be more or less aggressive. At step 112, the method 100 predicts powertrain loads and speeds using a powertrain and vehicle model and the retrieved route information. Using the predicted powertrain loads and speeds, at step 114, an optimized powertrain control strategy is then developed for the type of vehicle. For conventional vehicles, this means that e.g., shift maps for a shifting schedule can be modified. For HEVs and PHEVs, battery charging and discharging scheduling can be modified based on the desired aggressiveness of the schedule. Relevant engine commands needed to implement the new strategy are also developed. The predictive powertrain control strategy is executed at step 116.

It should be appreciated that the disclosed system 10 and method 100 enhance the real world fuel economy of the vehicle, allowing the vehicle's owner to save money on fuel. Better fuel economy is also beneficial to the environment because less fuel is being consumed and less emissions are entering the atmosphere. The disclosed system 10 and method 100 capitalize on information that is readily available from onboard components and systems already present within the vehicle. As such, the system 10 and method 100 are easily and inexpensively implemented into the vehicle. Moreover, the system 10 and method 100 disclosed herein do not require the driver to enter a route or other information to successfully operate and improve the vehicle's fuel economy.

What is claimed is:

1. A method of controlling a vehicle powertrain, said method comprising:
determining a present location of the vehicle;
predicting a route of travel for the vehicle from the present location based on the current day and time;
predicting powertrain loads and speeds based on the predicted route of travel; and
optimizing a powertrain operation based on the predicted powertrain loads and speeds.

2. The method of claim 1, wherein the optimized powertrain operation comprises one of shift scheduling and battery control.

3. The method of claim 1, wherein predicting the route of travel comprises:
determining if a next segment in a map database associated with a segment corresponding to the present location is traveled more than a predetermined threshold on a similar day and time as the current day and time; and
adding the next segment to the predicted route of travel if it is determined that the next segment is traveled more than the predetermined threshold on a similar day and time as the current day and time.

4. The method of claim 3, wherein the next segment is not added if additional information indicates that another segment should be added to the predicted route.

5. The method of claim 4, wherein the additional information is input from a vehicle to vehicle data source.

6. The method of claim 4, wherein the additional information is input from a vehicle to infrastructure data source.

7. The method of claim 4, wherein the additional information is input from a navigation system.

8. The method of claim 1, wherein predicting powertrain loads and speeds comprises determining route information for the predicted route of travel; and
determining the powertrain loads and speeds for the determined route information using a powertrain and vehicle model.

9. The method of claim 8, wherein the route information includes battery charging locations.

10. The method of claim 1, wherein determining the present location of the vehicle further comprises recording a present segment corresponding to the present location with a time stamp.

11. A powertrain apparatus for a vehicle, said apparatus comprising:
a controller adapted to:
determine a present location of the vehicle;
predict a route of travel for the vehicle from the present location based on the current day and time;
predict powertrain loads and speeds based on the predicted route of travel; and
optimize a powertrain operation based on the predicted powertrain loads and speeds.

12. The apparatus of claim 11, wherein the optimized powertrain operation comprises one of shift scheduling and battery control.

13. The apparatus of claim 11, wherein the controller predicts the route of travel by:
determining if a next segment in a map database associated with a segment corresponding to the present location is traveled more than a predetermined threshold on a similar day and time as the current day and time; and
adding the next segment to the predicted route of travel if it is determined that the next segment is traveled more than the predetermined threshold on a similar day and time as the current day and time.

14. The apparatus of claim 13, wherein the next segment is not added if additional information indicates that another segment should be added to the predicted route.

15. The apparatus of claim 14, wherein the additional information is input from a vehicle to vehicle data source.

16. The apparatus of claim 14, wherein the additional information is input from a vehicle to infrastructure data source.

17. The apparatus of claim 14, wherein the additional information is input from a navigation system.

18. The apparatus of claim 11, wherein the controller predicts powertrain loads and speeds by:
determining route information for the predicted route of travel; and
determining the powertrain loads and speeds for the determined route information using a powertrain and vehicle model.

19. The apparatus of claim 18, wherein the route information includes battery charging locations.

20. The apparatus of claim 11, wherein the controller records a present segment corresponding to the present location with a time stamp.
